(19) United States
(12) Patent Application Publication
(10) Pub. No.: US 2026/0133540 A1
(43) Pub. Date: May 14, 2026

(54) DECORATIVE OBJECT, IN PARTICULAR COMPRISING A DECORATIVE MODULE FOR A WATCH

(71) Applicant: RICHEMONT INTERNATIONAL SA, Steinhausen (CH)

(72) Inventors: Lucie MICHAUD, Morteau (FR); Kewin BAS, Villers le lac (FR); Romain MOYSE, Montlebon (FR)

(21) Appl. No.: 19/119,641

(22) PCT Filed: Nov. 20, 2023
(86) PCT No.: PCT/IB2023/061686

§ 371 Date: Apr. 9, 2025

(30) Foreign Application Priority Data
Nov. 25, 2022 (CH) 001416/2022

(51) Int. Cl. G04B 45/00

(52) U.S. Cl. CPC G04B 45/0038

(57) ABSTRACT

The invention relates to a decorative object (1.1, 12, 13, 14), in particular a wrist-watch or a pocket watch, comprising:
a first volume (V1) and a second volume (V2), together forming a sealed volume (V0);
a fluid (8) filling at least in part the first volume (V1) and the second volume (V2);
solid elements (11) able to move in suspension in the fluid and free to move throughout the first volume and only in the first volume, said solid elements being visible from outside the decorative object;
at least one wall (9) permeable to the fluid at the interface between the first volume and the second volume;
at least one zone defining a pattern;
a flow initiator able to cause a flow driving the fluid in the direction of said zone through said permeable wall so that the solid elements are arranged in said pattern; and
a control device (12, 13, 14) of the flow initiator.

The invention also relates to a decorative module (1.1) for such a timepiece.

The present invention relates to a decorative object, for example a timepiece or item of jewellery, typically comprising a decorative module and producing an optical effect.

The prior art, for example DE 8701203U1 , contains watches in which the glass, through which the dial can be seen, encloses a liquid containing suspended particles. Such a glass provides an attractive feature to the watch.

Patent EP 3 414 108 B1 describes an improved version of this type of watch glass and proposes a decorative module in which the suspended particles flow in a recessed pattern, typically etched in a lower glass and covered by an upper glass. In one particular embodiment of this invention, the beads are contained in the pattern, in which case this pattern is always visible. In another embodiment of the invention, the beads can enter and leave the pattern, in which case the pattern appears as soon as the dial is oriented with the channels downwards, the beads falling into the channels under the effect of gravity.

An aim of the present invention consists of proposing a decorative object of this type which offers more freedom in terms of the appearance of the pattern, typically one in which the appearance of the pattern is not necessarily dependent on gravity.

For this purpose, the present invention proposes a decorative object comprising:
a first volume and a second volume, together forming a sealed volume;
a fluid filling at least in part the first volume and the second volume;
solid elements able to move in suspension in the fluid and free to move throughout the first volume and only in the first volume, said solid elements being visible from outside the decorative object;
at least one wall permeable to the fluid at the interface between the first volume and the second volume;
at least one zone defining a pattern;
a flow initiator able to cause a flow driving the fluid in the direction of said zone through said permeable wall so that the solid elements are arranged in said pattern; and
a control device of the flow initiator.

As its name suggests, the control device makes it possible to control said flow initiator. It makes it possible to trigger the placement of the flow and thus of the pattern.

Depending upon the control device used, the flow and the placement of the pattern can be triggered randomly, automatically (programmed) or upon request. Therefore, the decorative object in accordance with the invention makes it possible to display a pattern by movable solid elements such as beads, randomly, automatically or upon request. The triggering of the display can thus be rendered independent of gravity.

In preferred embodiments of the invention, the flow initiator comprises a movable member. It is the movements of the movable member which cause the flow.

The movable member can typically move in translation or in rotation. It can be for example a piston, an impeller or a set of impellers.

Advantageously, the zone defining the pattern is arranged within the first volume or at the interface between the first volume and the second volume.

The zone defining the pattern is typically said permeable wall. In this case, the pattern of said zone is preferably defined by the arrangement and/or the size of through-going holes (pores, channels ...) of said permeable wall. In certain versions of the decorative object in accordance with the invention, the zone defining the pattern is formed using a device comprising at least two superimposed permeable walls. Relative movements of one permeable wall with respect to another can thus be provided in order to modify the positions and/or sizes (cross-section, e.g. diameter) of the holes and thereby change the pattern.

When the pattern of the zone defining the pattern is defined by the arrangement and/or the size of through-going holes, the decorative object in accordance with the invention can comprises channels containing the solid elements, said channels being arranged as extensions of said through-going holes such that the flow initiator causes flows pushing the solid elements in said channels at speeds depending upon the sizes of the different through-going holes.

When the zone defining the pattern is arranged within the first volume, said zone is typically the surface of said permeable wall located within the first volume. It can also be another surface defining the first volume. In both cases, said surface is preferably in relief.

In a preferred embodiment, the decorative object in accordance with the invention comprises two zones each defining a distinct pattern, each of said zones corresponding to a distinct surface arranged within the first volume and the flow initiator is able to cause, depending upon the command it receives from the control device, either a flow driving the fluid in the direction of a first of said zones through said permeable wall such that the solid elements are arranged in a first pattern, or a flow driving the fluid in the direction of the second of said zones through said permeable wall such that the solid elements are arranged in a second pattern.

In one particular embodiment, the decorative object in accordance with the invention further comprises at least one second permeable wall (in addition to the permeable wall(s) defined above), said second permeable wall also being located at the interface between the first and the second volume. This second wall makes it possible for fluid to flow from one of said volumes to the other, in a reverse direction from that passing through said at least one permeable wall. It thus improves the arrangement of the solid elements in the pattern

Advantageously, the flow initiator is also able to cause a flow driving the fluid in the direction of said zone defining a pattern through said at least one permeable wall in the opposite direction to the direction allowing the arrangement of the solid elements in said pattern. It thus typically allows said pattern to be “destroyed”.

In a particularly advantageous manner, the density of the solid elements is substantially equal to the density of the fluid. This has the advantage of at least partially obviating the direct effects of gravity on the solid elements. The density of the fluid typically differs by at most 10%, preferably at most 5%, even more preferably at most 2% of the density of the solid elements.

The decorative object in accordance with the invention is preferably a timepiece such as a pocket watch or wrist-watch.

Said timepiece typically comprises:
a decorative module comprising:
   a first volume and a second volume, together forming a sealed volume;
   a fluid filling at least in part the first volume and the second volume;
   solid elements able to move in suspension in the fluid and free to move throughout the first volume and only in the first volume, said solid elements being visible from outside said timepiece; at least one wall permeable to the fluid at the interface between the first volume and the second volume;
   at least one zone defining a pattern; and
   a flow initiator able to cause a flow driving the fluid in the direction of said zone through said permeable wall so that the solid elements are arranged in said pattern; and
a control device of the flow initiator.

The control device is typically located outside of the sealed volume of the decorative module and controls the flow initiator, in particular the movable member of the flow initiator as needed, mechanically or magnetically. Said movable member is preferably driven magnetically, which limits the stresses in terms of sealing tightness between the control device and the movable member.

Said decorative module typically comprises:
an upper glass, a lower glass and an annular frame defining the sealed volume;
a partition, at least a portion of which corresponds to said permeable wall, arranged between the upper and lower glasses and fixed with respect to said glasses, said partition delimiting on one side the first volume and on the other side the second volume; and
a piston arranged between said wall and one of said upper and lower glasses and constituting said movable member, the volume comprising said piston corresponding to said second volume.

Within the scope of the present invention, the term “glass” is understood to mean any plate formed of a material which is at least partially transparent and preferably fully transparent and colourless and which may or may not comprise an anti-reflective treatment.

As indicated above, the decorative object, whether or not it is a watch, is designed such that the movable solid elements are visible from the outside. A person skilled in the art knows how to use suitable materials and how to arrange them suitably to show off the pattern revealed by the solid elements. Within the scope of the present invention, it is certainly feasible that the walls defining the sealed volume are transparent only in a restricted part since it allows the solid elements to be seen.

The invention also relates to a decorative module for a wrist-watch or a pocket watch in accordance with the invention.

The decorative object in accordance with the present invention has, amongst other things, the advantage of being able to reveal the decorative pattern upon request or automatically by selecting a manual control device which can be controlled from the outside of the object, for example a push-button or sliding member, or by selecting an automatic control device. It is clear that the principle of the invention can also be used to make a “persistent”-type pattern disappear upon request or in a programmed manner, said pattern being formed under the effect of Archimedes' principle.

For this purpose, the invention proposes a decorative object comprising:
a first volume and a second volume, together forming a sealed volume,
a fluid filling at least in part the first volume and the second volume,
solid elements able to move in suspension in the fluid and free to move throughout the first volume and only in the first volume, said solid elements being visible from outside the decorative object,
at least one wall permeable to the fluid at the interface between the first volume and the second volume,
at least one zone defining a pattern in which the solid elements are intended to be positioned spontaneously, under the effect of Archimedes'principle, to define said pattern;
at least one flow initiator able to cause a flow driving the fluid in the direction of said zone through said permeable wall so as to move the solid elements so that they are arranged other than in said pattern; and
a control device of the flow initiator.

Within the scope of the invention, “zone defining a pattern in which the solid elements are intended to be positioned spontaneously, under the effect of Archimedes'principle, to define said pattern” is understood to mean a zone in which said solid elements come to be placed when the decorative object is at rest (a watch typically lying horizontally with the dial upwards), under the effect of Archimedes' principle.

Within the scope of the present invention, the fluid is preferably a liquid. Alternatively, it can be a gas.

Other features and advantages of the present invention will become clear upon reading the following detailed description given with reference to the attached drawings in which:

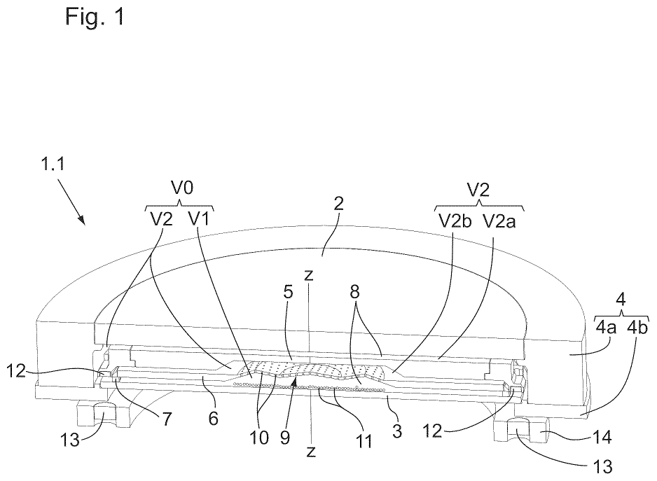

FIG. 1 shows a perspective, cross-sectional view of a part, called decorative module, of a watch in accordance with a first embodiment of the invention comprising a piston arranged in a first stable position;

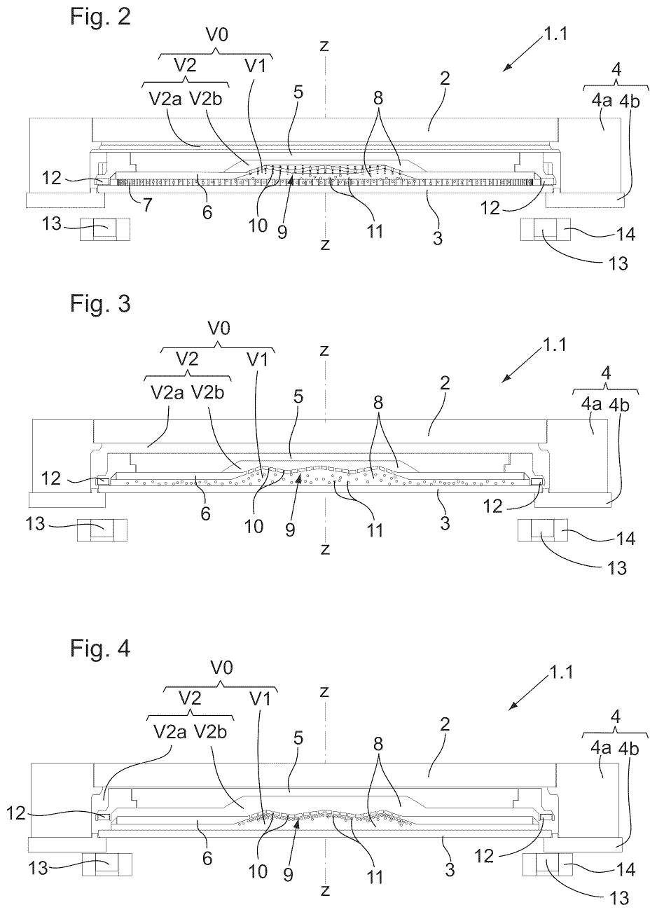

FIG. 2 is a transverse, cross-sectional view of the decorative module illustrated in FIG. 1;

FIG. 3 is a simplified, transverse, cross-sectional view (showing only the edges present in the sectional plane) of the module shown in FIG. 1;

FIG. 4 is a simplified, transverse, cross-sectional view of the decorative module shown in FIG. 1, in which the piston is arranged in a second stable position;

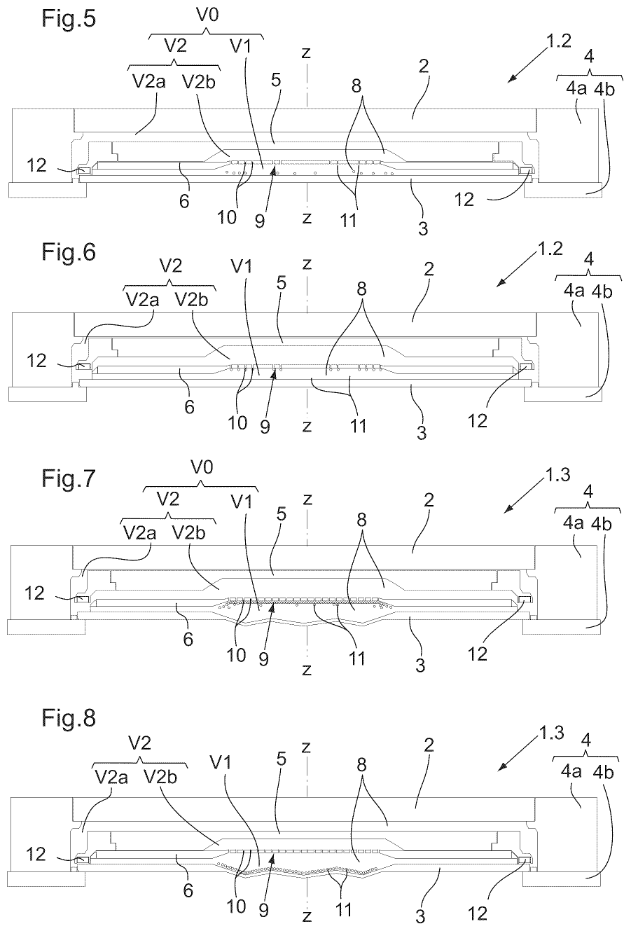

FIG. 5 is a simplified, transverse cross-sectional view of a decorative module for a watch in accordance with a second embodiment of the invention, said decorative module comprising a piston arranged in a first stable position;

FIG. 6 is a simplified, transverse, cross-sectional view of the decorative module shown in FIG. 5, in which the piston is in a second stable position;

FIG. 7 is a simplified, transverse, cross-sectional view of a decorative module for a watch in accordance with a third embodiment of the invention, said decorative module comprising a piston arranged in a first stable position;

FIG. 8 is a simplified, transverse, cross-sectional view of the decorative module shown in FIG. 7, in which the piston is in a second stable position;

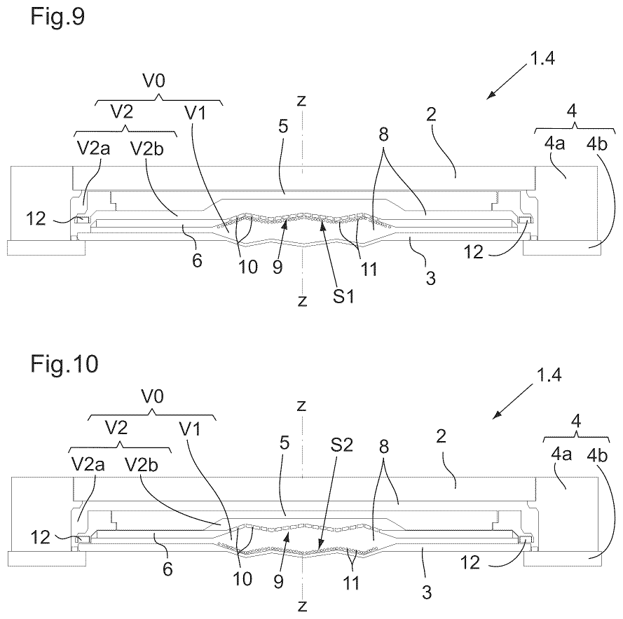

FIG. 9 is a simplified, transverse, cross-sectional view of a decorative module for a watch in accordance with a fourth embodiment of the invention, said decorative module comprising a piston arranged in a first stable position;

FIG. 10 is a simplified, transverse, cross-sectional view of the decorative module shown in FIG. 9, in which the piston is in a second stable position;

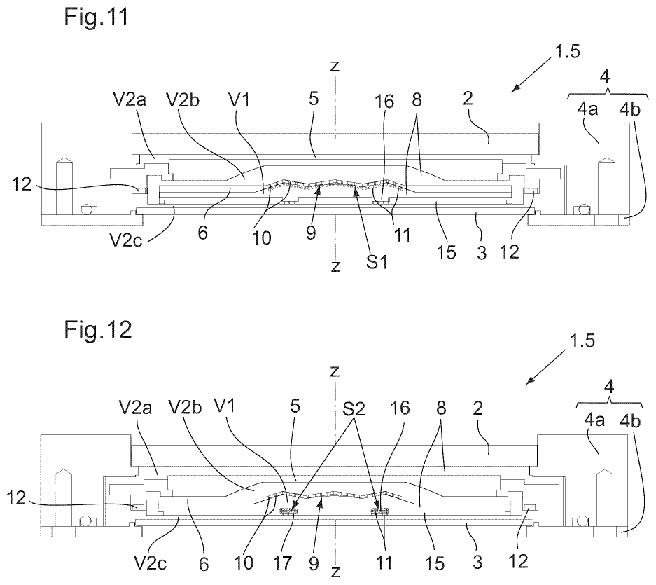

FIG. 11 is a simplified, transverse, cross-sectional view of a decorative module for a watch in accordance with a fifth embodiment of the invention, said decorative module comprising a piston arranged in a first stable position;

FIG. 12 is a simplified, transverse, cross-sectional view of the decorative module shown in FIG. 11, in which the piston is in a second stable position;

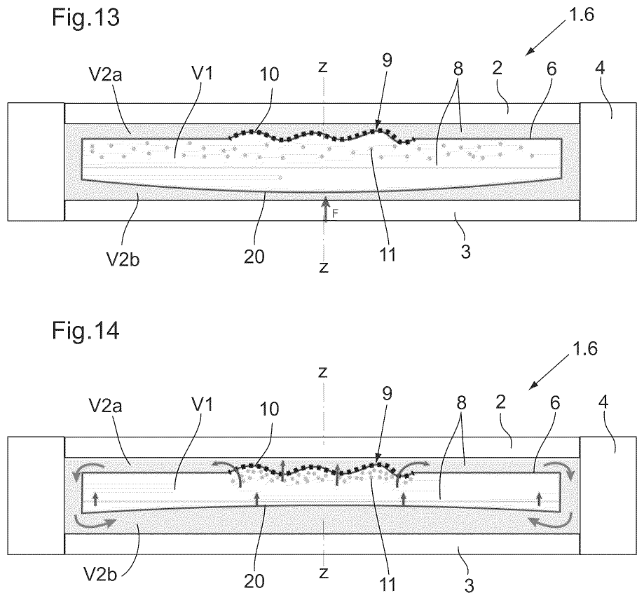

FIG. 13 is a schematic view showing a transverse cross-section of a decorative module for a watch in accordance with a sixth embodiment of the invention, said decorative module comprising a piston arranged in a first stable position;

FIG. 14 is a schematic view showing a transverse cross-section of the decorative module shown in FIG. 13, in which the piston is in a second stable position;

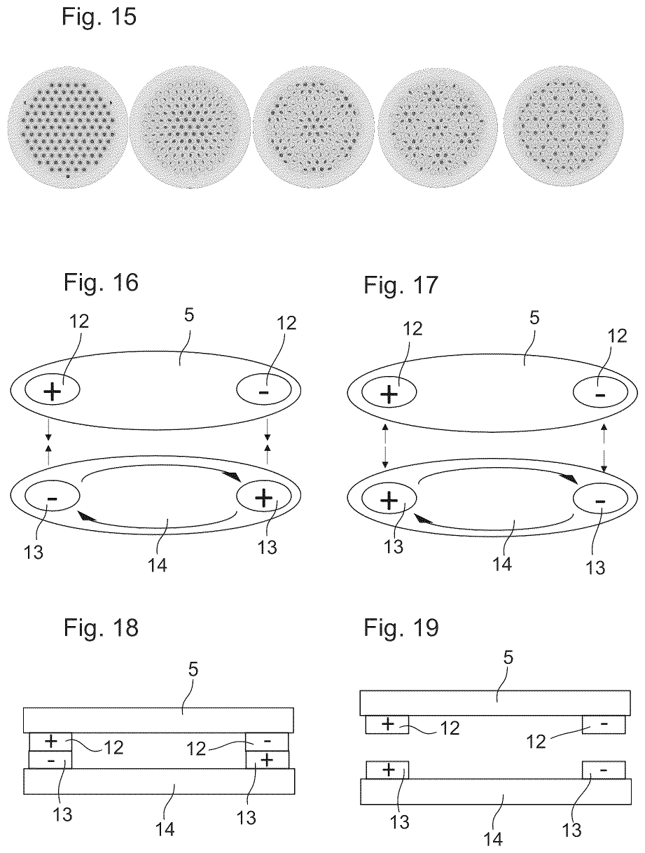

FIG. 15 illustrates a device used in a watch in accordance with a seventh or in accordance with an eighth embodiment of the invention;

FIGS. 16 to 19 schematically illustrate the control device of the watch piston illustrated in part in FIGS. 1 to 4 as well as its mode of operation.

The elements designated in FIGS. 5 to 19 by the same reference numerals as those used in FIGS. 1 to 4 are, unless stated otherwise, identical or similar to those described with reference to FIGS. 1 to 4.

With reference to FIG. 1, a watch in accordance with a first embodiment of the invention comprises a decorative module 1.1 and a control device.

The decorative module 1.1 comprises an upper glass 2 and a lower glass 3 which are transparent and fixed to an annular dial 4. The dial 4 is in two parts 4a, 4b which are fixedly attached to each other.

The upper glass 2, the lower glass 3 and the dial 4 together define a sealed volume V0.

Within the scope of the present invention, the terms “lower” and “upper” are defined with reference to the position of the decorative module 1.1 as shown in FIG. 1. The lower glass 3 is typically intended to cover the dial of the watch in accordance with the first embodiment of the invention and the upper glass 2 is, for its part, intended to be in contact with the exterior of the watch.

The decorative module 1.1 also comprises a piston 5 and a partition 6, both being at least partially transparent and preferably fully transparent. Their shape is adapted to that of the dial of the watch. In the illustrated example, they are generally in the shape of a disc. Alternatively, square, oval or non-straight shapes could be envisaged.

The piston 5 and the partition 6 are arranged in said sealed volume V0, between the upper glass 2 and lower glass 3. The partition 6 is typically mounted on the lower glass 3 via a ring 7 which can be seen in FIGS. 1 and 2, forming a circular grid. The piston 5 is, for its part, arranged between the partition 6 and the upper glass 2.

The lower glass 3, the ring 7 and the partition 6 delimit a first volume V1, included within the sealed volume V0. V2 will designate the second volume corresponding to the sealed volume V0 minus the first volume V1. The partition 6 is at the interface between the first volume V1 and the second volume V2. The volume V2 comprises two communicating sub-volumes V2a and V2b illustrated in the figures. V2a designates the part of the volume V2 located above the piston 5, i.e. between the piston 5 and the upper glass 2. V2b designates the part of the volume V2 located below the piston 5, i.e. between the piston 5 and the partition 6.

A liquid 8 fills the sealed volume V0. The liquid 8 is at least partially transparent, and preferably is fully transparent and colourless.

A portion, located in the centre of the partition 6 in the illustrated example comprises several through-going openings, typically holes, in this case through-going piercings 10, and is thus permeable to the liquid 8. This partition portion is designated in the rest of the description by the term “permeable wall 9”.

The permeable wall 9 and in particular the surface of this permeable wall 9 located within the volume V1 defines a relief pattern. The hollows defining the relief pattern are provided on the surface of the permeable wall 9, for example by etching, typically by laser etching, by machining, grinding, thermoforming and/or moulding.

Solid elements, in this case gold-covered hollow beads 11, suspended in the liquid 8 can move throughout the first volume V1 and only in this first volume V1. The beads 11 typically have the same density as the liquid 8 so that the movements thereof are determined by those of the piston 5. They are thus, amongst other things, theoretically unaffected by gravity.

The liquid 8 is able to flow throughout the sealed volume V0. It can flow between the volumes V1 and V2. The beads 11 are, for their part, kept in the first volume V1. Therefore, the piercings 10 do not allow the beads 11 to pass therethrough. This is also true for the openings in the ring 7.

The piston 5 is intended to move in translation along an axis z between a first stable position illustrated in FIGS. 1, 2 and 3 and a second stable position illustrated in FIG. 4. It is typically guided along the axis z via slide systems arranged between the boundaries of this piston 5 and the inner surface of the frame 4.

The piston 5 bears two magnets 12 which are located on its boundary and are diametrically opposite. They are typically glued into recesses provided for this purpose.

In the illustrated example, the device for driving the piston 5 comprises the two magnets 12 and a ring 14 bearing two diametrically opposite magnets 13 which are arranged such that they can be positioned facing the two magnets 12 along an axis in parallel with the axis z.

The ring 14 is intended to pivot about the axis z defined above, typically in jumps of 180°, such that its magnets 13 attract, every other step, and repel, every other step, the magnets 12 borne by the piston 5. FIGS. 16 to 19 schematically illustrate this principle.

Since the axial position of the ring 14 along the axis z is fixed, only the piston 5 moves along the axis z when the ring 14 pivots.

Driving the ring 14 in rotation by jumps can be controlled automatically, typically regularly, for example every hour, by a kinematic chain starting from the finishing going train of the watch. In this manner, every hour, the ring 14 pivots 180° and causes the movement of the piston 5 from one of its two stable positions to the other. Alternatively, it is also possible to envisage driving the ring 14 upon request by the user using an actuating member which can be accessed from the outside of the watch, or even driving this ring 14 randomly, e.g. using an unbalance.

Operation of the watch in accordance with the first embodiment of the invention is as follows:

When the piston 5 passes from the first stable position (illustrated in FIGS. 1, 2 and 3) to the second stable position (illustrated in FIG. 4), this creates a flow of liquid 8 towards the upper glass 2, from the first volume V1 to the second volume V2, through the piercings 10. This flow drives the beads 11 against the permeable wall 9 and in particular against the surface of this permeable wall 9 located within the volume V1 and defining the pattern. By being attracted by the flow of liquid 8 against this surface, the beads 11 come to fill the hollows forming the relief and are thus arranged in the pattern, as illustrated in FIG. 4. It goes without saying that the decorative module 1 comprises a number of beads 11 sufficient to represent this pattern.

When the piston 5 passes from the second stable position to the first stable position, this creates a flow of liquid 8 towards the lower glass 3, from the second volume V2 to the first volume V1, through the piercings 10. This flow moves the beads 11 away from the piercings 10, as illustrated in FIG. 3 for example. The beads 11 are generally dispersed in the volume V1 and their arrangement is quite random.

In the decorative module 1.1, the ring 7 allows, regardless of the movement of the piston 5, a flow of liquid 8 between the volumes V1 and V2 opposite to that passing through the permeable wall 9.

Typically, when the piston 5 rises and causes a flow of liquid 8 upwards (from V1 to V2) passing through the piercings 10, liquid 8 also passes from the volume V2 to the volume V1 passing through the grid of the ring 7. More precisely, when the piston 5 rises, the liquid 8 located in the volume V2a is driven into the volume V1, passing through the ring 7, and then rises from V1 to V2b. That is where the flow drives the beads 11 against the surface defining the pattern to reveal the pattern.

Inversely, when the piston 5 descends and causes a flow of liquid 8 downwards (from V2 to V1) passing through the piercings 10, liquid 8 also passes from the volume V1 to the volume V2 passing through the grid of the ring 7. More precisely, when the piston 5 descends, the liquid 8 located in the volume V2b is driven into the volume V1, passing through the permeable wall 9 and thereby “destroys” the pattern represented by the beads 11, and then it rises from V1 to V2a passing through the openings in the ring 7.

Such an inverse flow of liquid 8 allows, amongst other things, an improvement in the definition of the pattern by avoiding extraneous flows through the permeable wall 9.

FIGS. 5 and 6 show a decorative module 1.2 for a watch in accordance with a second embodiment of the invention.

Contrary to the zone defining the pattern of the decorative module 1.1 in accordance with the first embodiment, the zone of the decorative module 1.2 of the second embodiment of the invention which defines the pattern is not a relief surface. It is the permeable wall 9. In the second embodiment, this wall 9 has two parallel flat surfaces. The arrangement of the piercings 10 therein is not uniform and it is this arrangement which defines the pattern. When the piston 5 rises, the beads 11 tend to move closer to the piercings 10 and to be arranged in proximity thereto, thereby forming the pattern.

The other considerations relating to the watch in accordance with the first embodiment, in particular the manner in which the movements of the piston 5 are controlled, and the behaviour of the decorative module during the phases of revealing the pattern, are still valid in the second embodiment of the invention.

FIGS. 7 and 8 show a decorative module 1.3 for a watch in accordance with a third embodiment of the invention.

Contrary to the surface of the permeable wall 9 of the decorative module 1.1 defining the pattern, the surface of the permeable wall 9 of the decorative module 1.3 in accordance with the third embodiment of the invention located in the volume V1 is not used to define the pattern to be revealed. It is not a relief surface. The partition 6 comprises two flat surfaces in parallel with the upper glass 2 and the piercings 10 are preferably uniformly distributed. The aim of these piercings 10 is not to create a pattern as in the second embodiment but simply to allow a flow of liquid 8 along the axis z.

The surface defining the pattern corresponds in this case to the surface of the lower glass 3 located within the first volume V1.

Operation of the piston 5 of the decorative module 1.3 in accordance with the third embodiment is the same as that of the piston 5 of the first embodiment, except that in this case it is when the piston 5 passes from its high position shown in FIG. 7 to the low position shown in FIG. 8 that the pattern is revealed. In fact, when the piston 5 is lowered, it drives the beads 11 towards the lower glass 3 and thus against the relief surface defining the pattern.

When the piston 5 passes back to the top position shown in FIG. 7, this causes a flow of liquid 8 in the opposite direction. In the illustrated example, since the density of the beads 11 and of the liquid 8 is identical, the beads 11 come to rest against the permeable wall 9.

The other considerations relating to the watch in accordance with the first embodiment, in particular the manner in which the movements of the piston 5 are controlled, are still valid in the third embodiment of the invention.

FIGS. 9 and 10 show a decorative module 1.4 for a watch in accordance with a fourth embodiment of the invention.

This embodiment is very close to the third embodiment mentioned above. It differs from the third embodiment only in that the surface of the permeable wall 9 located in the first volume V1 itself defines a pattern (as in the decorative module 1.1). Therefore, in this embodiment the decorative module 1.4 comprises two surfaces S1 and S2, each defining a pattern, in this case a relief pattern. The first surface S1 is in the upper part of the first volume V1 (at the permeable wall 9) and the second surface S2 is at the upper part of the lower glass 3.

Therefore, each time the position of the piston 5 alternates, a pattern is revealed, a first one when the beads 11 rest against the surface S1 and a second one when the beads 11 rest against the surface S2. Said two patterns are preferably different.

It can be envisaged that the piston 5 can assume a stable intermediate position between its two stable positions. In this intermediate position, the beads 11 would be typically dispersed/in an intermediate position. Therefore, three displays would be possible depending upon whether the beads are grouped on the surface S1, on the surface S2, or dispersed.

The other considerations relating to the watch in accordance with the first embodiment, in particular the manner in which the piston 5 is controlled, are still valid in the fourth embodiment of the invention.

FIGS. 11 and 12 show a decorative module 1.5 for a watch in accordance with a fifth embodiment of the invention.

Just like the decorative modules 1.1, 1.2, 1.3 and 1.4, the decorative module 1.5 comprises an upper glass 2, a lower glass 3 and a frame 4 together defining a sealed volume V0. It also comprises a partition 6 and a piston 5 such as those defined in the first embodiment.

Just like the decorative module 1.4, the decorative module 1.5 comprises two surfaces S1 and S2, each defining a relief pattern and the entire assembly is arranged such that, each time the position of the piston 5 alternates, a pattern is revealed, a first one when the beads 11 rest against the surface S 1 and a second one when the beads 11 rest against the surface S2.

The partition 6 is identical to that of the decorative modules 1.1 and 1.4 and defines the surface S1 and the first recessed pattern.

The decorative module 1.5 also comprises an additional partition 15 arranged between the partition 6 and the lower glass 3 and connected to the partition 6. This additional partition 15 comprises, on its upper face, i.e. that oriented towards the upper glass 2, hollows 16 together forming the surface S2 and the second pattern. These hollows typically have a flat bottom and vertical edges; they are for example grooves. They preferably have a depth greater than the radius of the beads.

The bottom of each of the hollows 16 comprises through-going openings, in this case through-going piercings 17 intended to allow the liquid 8, but not the beads 11, to pass therethrough.

In this embodiment, the beads 11 suspended in the liquid 8 can move throughout the first volume V1 and only in the first volume V1. The volume V1 enclosing the beads 11 is, in contrast, defined differently from the volume V1 of the decorative modules 1.1, 1.2, 1.3 and 1.4. In this case, it is delimited, amongst other things, by the partition 6 and by the additional partition 15.

In order to understand the movements of the liquid 8, the volume V2 (V0 minus V1) is shown as the total of three communicating sub-volumes V2a, V2b and V2c.

When the piston 5 descends (passing from its stable position shown in FIG. 11 to that shown in FIG. 12), it causes a flow of liquid 8 from the volume V2b to the volume V 1, through the permeable wall 9. This causes the destruction of the first pattern by driving the beads 11 away from the surface S1. Then, the liquid 8 passes through the holes 17 of the hollows 16 and thereby drives the beads 11 into the bottom of the hollows 16 where they are arranged in the second pattern. The liquid 8 thus arrives in the volume V2c and in part rises again towards the volume V2a.

When the piston 5 rises again (passing from its stable position shown in FIG. 12 to that shown in FIG. 11), it drives the liquid from the volume V2a to the volume V2c and then the liquid is directed from V2c to V1 through the holes 17 which causes the destruction of the second pattern by driving the beads 11 out of the hollows 16. The liquid 8 continues its path and then passes through the holes 10 in the surface S1 to rejoin the volume V2b, driving the beads 11 into the hollows of the permeable wall 9 where they are arranged in the first pattern.

FIGS. 13 and 14 show a decorative module 1.6 for a watch in accordance with a sixth embodiment of the invention.

Just like the previously described decorative modules, the decorative module 1.6 comprises an upper glass 2, a lower glass 3 and a frame 4 together defining a sealed volume V0 filled with liquid 8, and beads 11 suspended in the liquid 8 and free to flow throughout a first volume V1 included in the sealed volume V0.

The decorative module 1.6 comprises a partition 6. This is typically identical to that of the decorative modules 1.1 and 1.4 and defines a recessed pattern.

The decorative module 1.6 also comprises an additional partition 20 arranged between the partition 6 and the lower glass 3 and connected to the partition 6. This additional partition 20 is able to be deformed to enlarge or shrink the volume V1 corresponding to the volume contained, amongst other things, between the partition 6 and the additional partition 20.

The decorative module 1.6 comprises a piston 5 (not shown) which interacts with the additional partition 20 or which forms part of the additional partition 20. Its movements are typically controlled like those of the pistons of the decorative modules 1.1, 1.2, 1.3, 1.4 and 1.5 using a control device as described with reference to FIGS. 1 to 4 and 16 to 19.

In order to understand the movements of the liquid 8, the volume V2 (V0 minus V1) is shown in FIGS. 13 and 14 as the total of two communicating sub-volumes V2a and V2b.

When the piston 5 rises (passing from its stable position shown in FIG. 13 to that shown in FIG. 14), the additional partition 20 and/or the piston drives the liquid 8 from the volume V1 to the volume V2a through the piercings 10 of the permeable wall 9 which causes the formation of the pattern by forcing the beads 11 against the recessed surface of the permeable wall 9. The liquid 8 then passes in part from the volume V2a to the volume V2b.

When the piston 5 descends (passing from its stable position shown in FIG. 14 to that shown in FIG. 13), the additional partition 20 and/or the piston drives the liquid 8 from the volume V2b to the volume V2a, then from the volume V2a to the volume V1 through the piercings 10 of the permeable wall 9 which causes the destruction of the pattern.

FIG. 15 illustrates a device intended to be used in a watch in accordance with a seventh embodiment or in accordance with an eighth embodiment of the invention.

The seventh embodiment of the invention differs from the previously presented embodiments in that the zone defining the pattern is not a physical surface against which the beads come to rest to reveal the pattern, but a zone allowing the creation of flows of liquid of different intensities in order to impact the different beads in a specific manner.

The principle consists of selecting the size of the piercings of the permeable wall to create flows of liquid of different intensities.

A watch in accordance with the seventh embodiment of the invention typically comprises a decorative module comprising, just like the decorative module 1.1, an upper glass and a lower glass which are transparent and are fixed on an annular frame and define a sealed volume filled with liquid.

The decorative module in accordance with the seventh embodiment also comprises beads in suspension in the liquid which are free to move in a first volume included in the sealed volume and a piston which can move in translation in parallel with the axis z in a second volume (the second volume corresponding to the sealed volume minus the first volume).

Just like in the embodiments mentioned above, the movements of the piston of the decorative object create flows of liquid moving the beads so that they reveal a pattern.

As in the other embodiments, the decorative module in accordance with the seventh embodiment of the invention comprises a partition, one portion of which located at the interface between the first and second volumes is permeable. The flow of liquid caused by the movement of the piston drives the liquid through the piercings of this permeable wall.

In this embodiment, the beads are housed in different channels, typically in parallel with the axis z. They can move only in these channels. Each channel is located as an extension of a piercing of the permeable wall and preferably contains a single bead having a diameter slightly less than the diameter of the corresponding channel.

The flow of liquid caused by the movement of the piston is influenced by the size of the piercing at the inlet of each of the channels; the larger the piercing (whilst always remaining smaller than the size of a bead), the greater the flow rate. Therefore, the beads of the different channels are driven to different heights in their respective channels. It is these different levels of the beads in the channels which allow the pattern to be revealed.

FIG. 15 shows a particularly type of device for a watch in accordance with the seventh embodiment of the invention. This device is intended to replace the permeable wall comprising piercings of different sizes. For this purpose, there is not one but two superimposed walls which define the piercings and their different diameters. The superimposed walls can move with respect to each other so as to vary the sizes and arrangement of the holes and thus to change the pattern to be revealed. This modification can be programmed so as to be produced spontaneously at certain times, e.g. every hour, randomly or in order to be manually controllable.

A decorative object in accordance with an eighth embodiment of the invention is identical in almost every detail to a decorative object in accordance with the seventh embodiment of the invention. The difference with the seventh embodiment is that the beads are intended to reach the bottom of the channels (the bottoms of different channels preferably being located at different heights) to define the pattern and that the size of the holes defined by the device shown in FIG. 15 allows the beads to move as far as the bottoms of said channels, defining specific transitory patterns.

In embodiments 1 to 8, the density of the liquid is identical or at least substantially equal to that of the beads such that the movements of the beads are defined only by those of the piston (in particular unaffected by gravity).

Without departing from the scope of the present invention, it is certainly feasible to proceed from a watch in accordance with one of embodiments 1, 4, 5 and 6 and to change the density of either the beads or the liquid such that the beads will spontaneously “float” under the effect of Archimedes'principle in order to be arranged in a pattern.

For example, in the embodiment illustrated in FIGS. 1 to 4, if the beads 11 had a density lower than that of the liquid 8, they would be spontaneously positioned in the hollows of the permeable wall in order to form the pattern. The act of moving the piston 5 from its high position (FIG. 4) to its low position (FIG. 3) would allow the pattern to be destroyed, said pattern otherwise reforming spontaneously more or less quickly depending upon the values of said densities.

Thus, other embodiments of the invention can relate to watches comprising a decorative module as described above and a device for controlling the piston of this decorative module, wherein the piston is arranged such that the flow which it causes when it is actuated by the control initiator allows the arrangement of the beads in a manner other than in the pattern. In other words, the piston is arranged such that the flow allows the pattern formed spontaneously under the effect of Archimedes'principle to be destroyed.

In still other embodiments, it is also possible to envisage the case where the bead/liquid density ratio is such that the beads fall, typically under the effect of gravity, or rise, typically under the effect of Archimedes'principle, so as not to define a pattern. A piston movement can thus create a flow of liquid allowing the fleeting formation of the pattern which will be destroyed spontaneously, more or less quickly depending upon the selected densities.

In such cases, the piston can comprise a valve so as to be able to form a flow of liquid only in a single direction, namely the one bringing the beads to the position opposite that which they would adopt spontaneously.

Whatever the embodiment of the invention, the lower glass of the decorative module is typically formed of one of the following materials: borosilicate, crystal glass, fused silica, optical crown glass, flint glass, quartz, transparent ceramic, sapphire, polymethyl methacrylate, polycarbonate, polyurethane.

The partition and the piston are typically also designed in one of these materials.

Finally, the upper glass can also be formed of one of these materials, but it is preferably of a harder material, e.g. sapphire. This hardness provides the upper glass with better resistance to scratches, which is an advantage when the upper glass is in contact with the exterior of the watch.

Whatever the case may be, in a watch in accordance with the invention it is preferable that each of the members—upper glass, lower glass, partition(s) and piston—of the decorative module is produced, at least in part, from a transparent material in the sense that the decorative module is intended to cover a dial bearing, amongst other things, the display of the time.

Without departing from the scope of the invention, a sealed channel can pass through the volume comprising the liquid, the channel allowing passage of a cannon-pinion or pipe such that the displaying of the time, for example, is effected above the enclosure comprising the liquid volume. The watchmaker will thus only have to ensure that the decorative beads are visible and that the different elements (glasses, partition, piston) make this possible.

The refractive index of the liquid is preferably equal to that of the zone(s) defining the pattern or sufficiently close thereto (different by no more than 10%, preferably 5%, even more preferably 2%) such that the or said zone(s) are substantially invisible. The expression “refractive index” is understood to mean, within the scope of the present invention, a refractive index measured at a wavelength of 700 nm, at a temperature of 20 to 25° C. and at atmospheric pressure.

In the particular case of a decorative module for a watch, the refractive index of the liquid is preferably close to that of the permeable wall of the partition delimiting the first and second volumes such that the zone defining the pattern is substantially invisible. Advantageously, the upper and lower glasses as well as the piston also have refractive indices of the same order.

When etched, the relief surfaces—the permeable wall 9 of the decorative module or the lower glass 3 of the decorative module—are preferably made from borosilicate, or fused silica, materials which are well suited to being etched. In this case, the liquid 8 has a refractive index which is approximately 1.47 (refractive index of borosilicate). It is, for example, glycerol or a mineral oil, preferably a mineral oil.

Whatever the embodiment of the invention, the beads are for example hollow, impervious and covered with a colouring material such as gold. In order for them to have a density close to that of the liquid, they preferably have a very thin wall. They are typically hollow, glass, with a very thin coating (<1 micron or even<0.3 micron) comprising gold (or other colouring materials). This has the advantage of at least partially obviating the direct effects of gravity on said beads.

A person skilled in the art can select the thickness of this wall to adjust the ratio of the densities of the liquid and beads.

If the density of the fluid is sufficient, it is also possible to envisage having solid beads made from synthetic material such as PMMA with a coating made of metal, such as gold. Once again, the density of the beads could be adjusted by selecting the thickness of gold.

The preceding description focuses to describe particular embodiments by way of non-limiting illustration, and the invention is not limited to the implementation of some particular features which have just been described, such as for example the structure and operation of the control device, the illustrated shapes and described materials for the different components.

In the illustrated embodiments, the solid elements are beads. These solid elements could be something other than beads and take any suitable shape. They could also be made from materials other than those cited above.

In the illustrated embodiments, the flow driving the liquid in the direction of the zone defining the pattern is caused by a piston which can move in translation and is controlled by a pivoting magnetic control device. It is clear that the ring 14 of the magnetic control device described with reference to FIGS. 1 to 4 could be different. It could typically comprise a single magnet or more than two magnets, for example four magnets uniformly distributed around the periphery of the ring which would thus move in steps of 90°, or eight magnets uniformly distributed around the periphery of the ring which would thus move in steps of 45°, in order to make the piston rise and then descend. This angle of rotation could be decreased by multiplying the number of magnets following this same logic.

The ring 14 may not be driven automatically by the movement of the watch in which it is mounted, but be simply unbalanced and pivot under the effect of the movements of the wearer of the watch, i.e. randomly. The ring 14 could also be driven in rotation by successive steps voluntarily, typically by the wearer of the watch pressing on a push-button.

In other variants, it could also be envisaged to guide the piston rotationally, not by using slides but rather a thread-type helicoidal guiding system.

The flow of liquid could also be created by an element which can move in rotation, rather than in translation, like an impeller or a set of rotary impellers, or even by means other than a mobile element, for example via waves or a temperature difference.

The relief patterns can be obtained by methods other than those mentioned above, any other methods allowing parts to be produced in 3D could be suitable.

In the illustrated examples, the liquid fills the sealed volume. It could also be envisaged that it fills the volume only partially, since the described liquid flows remain possible. Furthermore, the liquid filling the sealed volume could be replaced by a fluid in the form of a gas.

Finally, whilst the decorative object mentioned in the illustrated examples is a watch, it is clear that the invention is not limited to this object.

1. Decorative object (1.1; 1.2; 1.3; 1.4; 1.5; 1.6, 12, 13, 14) comprising:
a first volume (V1) and a second volume (V2), together forming a sealed volume (VO);
a fluid (8) filling at least in part the first volume (V1) and the second volume (V2);
solid elements (11) able to move in suspension in the fluid and free to move throughout the first volume and only in the first volume, said solid elements being visible from outside the decorative object;
at least one wall (9) permeable to the fluid (8) at the interface between the first volume (V1) and the second volume (V2);
at least one zone defining a pattern;
a flow initiator able to cause a flow driving the fluid in the direction of said zone through said permeable wall so that the solid elements (11) are arranged in said pattern ; and
a control device (12, 13, 14) of the flow initiator.

2. Decorative object (1.1; 1.2; 1.3; 1.4; 1.5; 1.6, 12, 13, 14) as claimed in claim 1, characterised in that said flow initiator comprises a movable member (5), the movements of which cause said flow.

3. Decorative object (1.1; 1.2; 1.3; 1.4; 1.5; 1.6, 12, 13, 14) as claimed in claim 2, characterised in that said movable member (5) is driven mechanically or magnetically, preferably magnetically.

4. Decorative object (1.1; 1.2; 1.3; 1.4; 1.5; 1.6, 12, 13, 14) as claimed in claim 1, characterised in that said zone defining the pattern is arranged within the first volume (V1) or at the interface between the first volume (V1) and the second volume (V2).

5. Decorative object (1.1; 1.2; 1.4; 1.5; 1.6, 12, 13, 14) as claimed in claim 4, characterised in that said zone defining the pattern is said permeable wall (9).

6. Decorative object (1.2, 12, 13, 14) as claimed in claim 5, characterised in that the pattern of said zone is defined by the arrangement and/or size of holes (10) passing through said permeable wall (9).

7. Decorative object as claimed in claim characterised in that the zone defining the pattern is formed using a device comprising at least two superimposed permeable walls.

8. Decorative object as claimed in claim 6, characterised in that it comprises channels containing the solid elements and arranged as extensions of said through-going holes such that the flow initiator causes flows pushing the solid elements in said channels at speeds dependent upon the diameters of the different through-going holes.

9. Decorative object (1.1; 1.2; 1.4; 1.5; 1.6, 12, 13, 14) as claimed in claim 4, characterised in that said zone defining the pattern is the surface (S1) of said permeable wall (9) located within the first volume (V1).

10. Decorative object (1.1; 1.4; 1.5; 1.6, 12, 13, 14) as claimed in claim 9, characterised in that said surface is in relief.

11. Decorative object (1.4; 1.5, 12, 13, 14) as claimed in claim characterised in that it comprises two zones each defining a distinct pattern, each of said zones corresponding to a distinct surface (S1, S2) arranged within the first volume (V1) and in that the flow initiator is able to cause, depending upon the command it receives from the control device, either a flow driving the fluid (8) in the direction of a first of said zones through said permeable wall such that the solid elements are arranged in a first pattern, or a flow driving the fluid in the direction of the second of said zones through said permeable wall (9) such that the solid elements are arranged in a second pattern.

12. Decorative object (1.1; 1.2; 1.3; 1.4; 1.5; 1.6, 12, 13, 14) as claimed in claim 1, characterised in that it further comprises at least one second permeable wall (7) at the interface between the first volume (V1) and the second volume (V2) which allows a flow of fluid (8) from one of said volumes to the other in a direction opposite that passing through said permeable wall (9).

13. Decorative object (1.1; 1.2; 1.3; 1.4; 1.5, 12, 13, 14) as claimed in claim 1, characterised in that the flow initiator is also able to cause a flow driving the fluid (8) in the direction of said zone through said permeable wall (9) in the direction opposite to the direction allowing the arrangement of the solid elements (11) in said pattern.

14. Decorative object (1.1; 1.2; 1.3; 1.4; 1.5; 1.6, 12, 13, 14) as claimed in claim 1, characterised in that the density of the solid elements (11) is substantially equal to the density of the fluid (8).

15. Decorative object (1.1; 1.2; 1.3; 1.4; 1.5; 1.6, 12, 13, 14) as claimed in claim 1, characterised in that it is a timepiece such as a wrist-watch or a pocket watch
comprising:
a decorative module (1.1; 1.2; 1.3; 1.4; 1.5; 1.6) comprising:
a first volume (V1) and a second volume (V2), together forming a sealed volume (V0);
a fluid (8) filling at least in part the first volume and the second volume;
solid elements able to move in suspension in the fluid and free to move throughout the first volume and only in the first volume, said solid elements being visible from outside said timepiece;
at least one wall (9) permeable to the fluid at the interface between the first volume and the second volume;
at least one zone defining a pattern; and
a flow initiator able to cause a flow driving the fluid in the direction of said zone through said permeable wall so that the solid elements are arranged in said pattern; and
a control device (12, 13, 14) of the flow initiator.

16. Timepiece as claimed in claim 15, characterised in that said decorative module (1.1; 1.2; 1.3; 1.4; 1.5; 1.6) comprises:
an upper glass (2), a lower glass (3) and an annular frame (4) defining the sealed volume (V0);
a partition (6), at least a portion of which corresponds to said permeable wall (9), arranged between the upper and lower glasses and fixed with respect to said glasses, said partition delimiting on one side the first volume and on the other side the second volume; and
a piston (5) arranged between said partition and one of said upper and lower glasses and forming said movable member, the volume comprising said piston corresponding to said second volume.

17. Decorative module (1.1; 1.2; 1.3; 1.4; 1.5; 1.6) for a wrist-watch or a pocket watch as claimed in claim 15.

18. Decorative object comprising:
a first volume and a second volume, together forming a sealed volume (VO);
a fluid filling at least in part the first volume and the second volume;
solid elements able to move in suspension in the fluid and free to move throughout the first volume and only in the first volume, said solid elements being visible from outside the decorative object;
at least one wall permeable to the fluid at the interface between the first volume and the second volume;
at least one zone defining a pattern in which the solid elements are intended to be positioned spontaneously, under the effect of Archimedes'principle, to define said pattern;
a flow initiator able to cause a flow driving the fluid in the direction of said zone through said permeable wall so as to move the solid elements so that they are arranged other than in said pattern; and a control device of the flow initiator.
